(19) United States
(12) Patent Application Publication
(10) Pub. No.: US 2004/0023613 A1
(43) Pub. Date: Feb. 5, 2004

(54) Decontaminable safety work bench

(76) Inventors: Walter Gluck, Hasselroth (DE); Gerd Ross, Frankfurt (DE)

Correspondence Address: BAKER & HOSTETLER LLP, Washington Square, Suite 1100, 1050 Connecticut Avenue, N.W., WASHINGTON, DC, 20036, US

(21) Appl. No.: 10/352,147

(22) Filed: Jan. 28, 2003

(30) Foreign Application Priority Data
Jan. 28, 2002 (DE) DE 10203234.3

(51) Int. Cl. F24F 7/00; F23J 11/00; F24F 11/00; F24F 13/00; B08B 15/02; F24C 15/20

(52) U.S. Cl. 454/57

(57) ABSTRACT

The invention concerns a safety work bench with a work space, enclosed by a housing, and a ventilation system for the ventilation of this work space. The safety work bench also comprises an ozone generator which feeds ozone into the ventilation system so as to decontaminate the safety work bench.

The invention also concerns a method for the decontamination of a safety work bench and the use of ozone for this purpose.

The invention concerns a safety work bench which can be decontaminated using ozone.

Microbiological safety work benches of Classes 1 to 3 are used for the processing of biological materials in laboratory work. Such safety work benches have a special ventilation system which prevents the biological materials from exiting the work space of the safety work bench into the environment during their processing and contaminating the workers. The safety work benches, above all those of Class 2, contribute furthermore to preventing contaminations of the processed material.

In the processing of biological samples, aerosols of agents which may be hazardous under certain circumstances are released within the work bench. As a result of the air circulation within the safety work bench, the aerosols are distributed within the entire ventilation system of the equipment. Special high-performance suspended matter filters (for example, the so-called “HEPA” and “ULPA” filters) prevent the biological materials in the safety work bench from escaping to the outside and contaminating the environment.

As already mentioned, the aerosols, however, are distributed within the safety work bench. In order to prevent new cultures from being contaminated with foreign biological material, it is therefore necessary that the interior of the safety work bench be disinfected regularly, usually daily. This is routinely done with a spray disinfectant, which is sprayed on the surfaces surrounding the work space and subsequently wiped off. In this way, the work space of the safety work bench can be disinfected; surfaces such as ventilation channels and filters which are not directly accessible cannot be disinfected in this manner, on the other hand. This is also true for the alternative method of decontamination, which is regularly used with safety work benches—namely the method of decontamination with UV-C rays.

In order to guarantee safe work in the long term and to prevent the entrainment of foreign materials into processed cultures, ventilation channels and filters must also be regularly decontaminated. An internationally recognized standard for the total decontamination of safety work benches is gassing with formaldehyde vapor. The disadvantage of this method, however, is that the formaldehyde remains in the safety work bench for several days after disinfection and thus, in addition to the germs to be killed, also damages the subsequently processed useful cultures within the apparatus and leads to errors in the investigation results.

Moreover, the disinfection with formaldehyde may only be carried out with the plant's own trained technical personnel, who must undergo repeated qualification tests. Before carrying out a disinfection with formaldehyde, furthermore, the competent authorities must be informed. The time and financial expenditure in carrying out the formaldehyde disinfection is therefore considerable and no longer tolerable for many enterprises. As an alternative to the formaldehyde disinfection, there is also decontamination with hydrogen peroxide. This disinfectant, however, is effective only with special agents and also requires very cumbersome and expensive special equipment. Hydrogen peroxide disinfection cannot be used, therefore, as a routine measure.

The goal of the invention is, accordingly, to give a possibility for disinfecting safety work benches, which can be used routinely with the lowest possible expenditure for the total decontamination of safety work benches. It should be possible to carry out the decontamination with personnel who do not have special training; it should have a broad spectrum of activity; and at the same time, it should practically rule out any damage to the environment outside the safety work bench. The disinfection method should also be usable in already existing safety work benches with an appropriate upgrading.

This goal can be attained with the safety work bench in accordance with claim 1 and the method in accordance with claim 11. Preferred embodiments and method variants can be found in the individual subclaims. The invention also concerns the use of ozone for the decontamination of safety work benches.

The invention is therefore based on the knowledge that ozone is excellent for the decontamination of safety work benches. Ozone is gaseous so that the decontamination of ventilation shafts and filters with this disinfectant does not represent a problem. Ozone is also a recognized disinfectant which has a very broad spectrum of activity. The contaminations which usually appear in safety work benches can be eliminated with ozone. In addition, ozone has the advantage that it can be easily produced and also can be easily degraded once again. Oxygen, which is completely harmless to the environment, is formed as the degradation product of the ozone.

The safety work bench in accordance with the invention has an ozone generator for the production of the ozone. This is situated in the safety work bench in such a way that the produced ozone is supplied to the ventilation system of the safety work bench. The ozone is transported with the ventilation air, which provides for a clean air atmosphere within the safety work bench, through all areas of the safety work bench, into which the aerosols formed from the biological materials are introduced. During decontamination, the ozone therefore reaches all areas of the work space, the ventilation system, and the filter, in which biological material could have been deposited also.

To produce the ozone, any known ozone generator can be used. The production of the ozone is suitable by means of UV radiation or electrically via a spark gap. The ozone generator can be located anywhere in the safety work bench which permits a supply of ozone into the ventilation flow. The ozone generator is preferably placed outside the work space of the safety work bench, for example, in the area of a ventilation channel of the ventilation system and preferably on an easily accessible site of the apparatus. The upgrading of already existing safety work benches by the subsequent incorporation of the ozone generator is readily possible.

In order to prevent ozone from the safety work bench from reaching the outside, the safety work bench is closed aerosol-tight during the decontamination. Such tightly closing work benches are basically already known and, for example, described in DE 4441784 C2 of the applicant. However, the invention can be used in safety work benches which, in fact, do not close tightly. They are then appropriately sealed off with respect to the environment with suitable sealing agents before the decontamination.

In order to prevent a discharge of the ozone after the end of the decontamination, the safety work bench in accordance with the invention preferably has a device for the degradation of the ozone. This is expediently integrated into the waste air device of the safety work bench. The degradation device for the ozone can be, for example, a filter or a catalyst. A platinum-iridium catalyst, for example, which degrades the ozone to oxygen, is suitable. For the case that the degradation device must be replaced or regenerated, it is expediently situated in the safety work bench in such a way that it can be easily reached.

In order to prevent a reduced pressure from forming during the discharge of the decontamination flow from the safety work bench in the interior of the same, a valve is expediently provided in the device, with which ambient air for a pressure compensation can be conducted into the ventilation system. The valve can also be used so as to supply the interior of the work bench with fresh air, so that sufficient oxygen is available for the production of the ozone.

In order to guarantee a complete decontamination of the safety work bench with ozone, in accordance with the invention, the decontamination preferably takes place over several hours, with particular preference, overnight. The decontamination method, in accordance with the invention, can be applied in such a simple manner that it can be carried out daily. In a particularly preferred variant of the invention, the safety work bench has a control device, with which the decontamination can be carried out automatically, at least in part. Preferably, it is carried out in a completely automatic manner.

Appropriately, the control device also has means to detect and evaluate certain apparatus parameters and/or means to indicate disturbances. For example, the control can be set in such a way that a starting of the ozone production is possible only when it has been ensured that the safety work bench is closed aerosol-tight with respect to the environment. For this, sensors, which send a signal to the control device, are present, for example, in the area of a front pane, which can be closed aerosol-tight and which closes the work opening of the work space; they send a signal to the control device when the front pane is actually closed tightly. Only when this signal has reached the control device is the ozone generator started by the control device. Other apparatus parameters which can be considered are, for example, the functioning of the ventilation or the orderly connection and functioning of the ozone degradation device. Also, the ozone production time can be adjusted and automatically controlled. Moreover, provision can be made so that the ozone production is interrupted, if in the course of the decontamination a disturbance in the system is detected. It is also expedient to automatically lock the front pane during the decontamination, so as to prevent an unintended opening in the course of the decontamination method. An emergency locking can also be provided.

The indication of any disturbances can take place, for example, optically or acoustically. For the optical indication, a warning blinking light or a display can be situated on the safety work bench, for example. The acoustic warning can be released by a siren or something similar.

The invention will be explained in more detail, below, with the aid of a drawing.

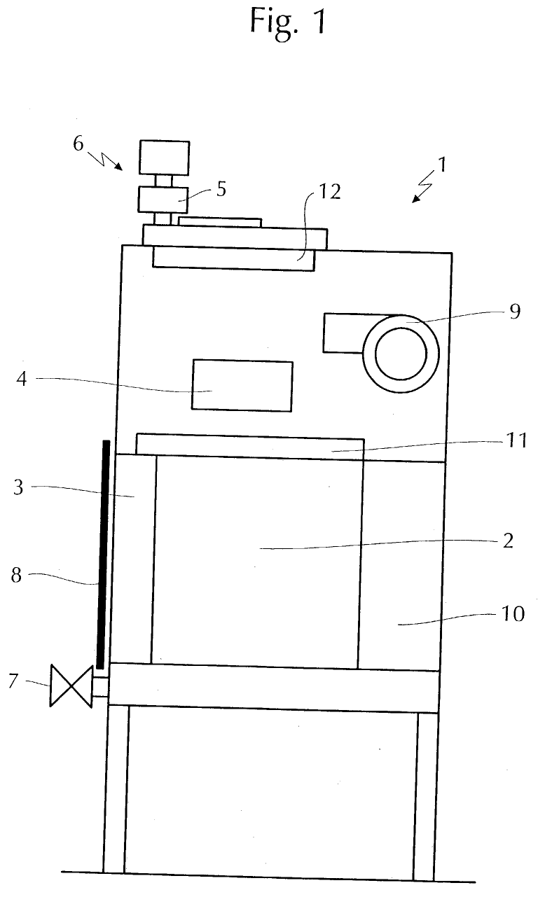

FIG. 1 shows, schematically, a safety work bench, in cross section, in accordance with the invention.

The safety work bench 1, shown in FIG. 1, essentially corresponds to a traditional safety work bench, as it is described, for example, in DE 4441784 C2. In a housing 3, there is a work space 2, in which samples can be processed. The work space is accessible via a work space opening on the front side of the work space 2 (in the FIGURE, on the left side), which can be closed with a front pane 8, whose height can be adjusted. During the processing of samples in the work space 2, the front pane 8 is pushed up, at least in part. In order to prevent a contamination of the samples in the work space 2 and a discharge of sample material from the work space 2 to the outside, air is circulated within the safety work bench 1. A ventilator 9 is located for this in the space above the work space 2. Filters 11 and 12 are also present for the purification of the circulated air.

During the processing of the samples, sample material is distributed in the form of aerosols with the circulating air in the interior of the safety work bench 1. In this way, sample material can be deposited on the walls of the work space 2, in the ventilation channel 10, in the ventilator 9, and in the ventilation space surrounding it, and in filters 11 and 12, and furthermore, in the waste air device 6. Whereas the walls of the work space 2 can be decontaminated with traditional spray decontaminants, this method is not possible with the other work spaces mentioned. In accordance with the invention, the decontamination of all these spaces is carried out, however, with gaseous ozone, which is circulated through the ventilation system of the safety work bench. The work space 2 can also be cleaned with a traditional disinfectant before and after the ozone decontamination.

An ozone generator 4 is provided for the production of ozone in the safety work bench 1. In the indicated case, the ozone generator 4 is located in the ventilation space above the work space 2. Ozone released into this space is circulated by the normal ventilation system by means of the ventilator 9 through the interior of the safety work bench 1. The ventilation air enriched with ozone, therefore, first moves through the filter 11 into the work space 2 and from there through the ventilation channel 10 back into the upper ventilation space. From here, ozone is also introduced into the filter 12. Within this circulation, the ventilation air enriched with ozone circulates for several hours. The effective time can be selected in accordance with the microbes previously processed in the work space 2.

So that no ozone can be discharged out from the safety work bench 1, it is closed aerosol-tight before ozone generation is begun. With safety work benches with hermetically closing front panes, as they are described in DE 4441784 C2, this is done simply by closing the front pane. In other cases, the safety work bench is closed with suitable additional sealing agents. Also the discharging device 6 remains closed during the ozone production, so that here too, no ozone can reach the outside.

After the end of the ozone gassing, the gassing air is released to the outside from the safety work bench by the waste air device 6. For this, the outlet is opened and at the same time, care must be taken that in accordance with the discharged air, ambient air can penetrate from the outside into the ventilation system of the safety work bench. This is possible either in that an air supply opening is created manually, for example, by opening the front pane, or preferably a valve 7, which ensures the air supply into the ventilation system, is provided on the safety work bench. The ventilation system can also be supplied with air, via this valve, during the ozone gassing, so that sufficient oxygen is present as the starting material for the ozone in the system. Preferably, the valve is a magnetic valve, which is opened and closed with the control device of the safety work bench, so as to be able to carry out a completely automatic decontamination. In the indicated case, the valve is situated on the front side of the safety work bench. However, it is also possible to provide the valve 7 somewhere else in the safety work bench, for example, in an area of the housing 3 below the work space 2. The placement of the ozone generator 4 is not limited to the space above the work space 7 either. An alternative placement site is, for example, the back ventilation channel 10.

For the discharge of the decontamination air from the safety work bench 1, an additional blower furnished for ventilation can be provided in the waste air device 6. This blower first conveys the decontamination air from the interior of the safety work bench 1, via the filter 12, into the device 5 for the degradation of the ozone. Within this device 5, a filter or catalyst, preferably a platinum-iridium catalyst, is located, which degrades any ozone present to oxygen. The air discharged from the waste air device 6 from the safety work bench 1 is completely harmless to the environment. No residues of disinfectants remain in the interior of the safety work bench which could damage samples processed after the decontamination.

1. Safety work bench (1) with a housing (3), enclosing a work space (2), and a ventilation system for the ventilating of the work space (2), characterized in that it comprises an ozone generator (4) to supply ozone into the ventilation system.

2. Safety work bench according to claim 1, characterized in that the ozone generator (4) comprises a UV radiator or a means for the electrical production of ozone.

3. Safety work bench according to claim 1 or 2, characterized in that the ozone generator (4) is located in the area of a ventilation channel of the ventilation system outside the work space (2).

4. Safety work bench according to one of claims 1 to 3, characterized in that it comprises a device (5) for the degradation of the ozone.

5. Safety work bench according to claim 4, characterized in that the device (5) for the degradation of the ozone is integrated into the waste air device (6) of the safety work bench (1).

6. Safety work bench according to claim 4 or 5, characterized in that the device (5) for the ozone degradation comprises a filter or catalyst, in particular, a platinum-iridium catalyst.

7. Safety work bench according to one of claims 1 to 6, characterized in that it comprises a valve (7) for the supply of ambient air into the ventilation system.

8. Safety work bench according to one of claims 1 to 7, characterized in that it has a front pane (8) for the closing of the work opening of the work space (2), which can close aerosol-tight.

9. Safety work bench according to one of claims I to 8, characterized in that it has a control device for the at least partial automatic control of the ozone generator (4) and the ventilation system.

10. Safety work bench according to claim 9, characterized in that the control device comprises means to detect and evaluate apparatus parameters and/or means to indicate disturbances.

11. Method for the decontamination of a safety work bench (1), which comprises a work space (2), enclosed by a housing (3), and a ventilation system for the ventilation of the work space (2), characterized in that ozone produced by an ozone generator (4) is fed into the ventilation system and is conducted through the work space (2) by means of the ventilation system.

12. Method according to claim 11, characterized in that the production and conduction of the ozone takes place for several hours.

13. Method according to claim 11 or 12, characterized in that the ozone is conducted via a device (5) for the degradation of the ozone after the decontamination has ended.

14. Method according to one of claims 11 to 13, characterized in that the safety work bench (1) is closed off aerosol-tight with respect to the environment before ozone production is begun.

15. Method according to one of claims 1 to 14, characterized in that the decontamination with ozone is controlled by a control device in an at least partially automatic manner.

16. Method according to claim 15, characterized in that the safety work bench (1) comprises means to detect and evaluate apparatus parameters and means to indicate disturbances and that the ozone production is interrupted when a disturbance is detected.

17. Method according to one of claims 1 to 16, characterized in that the work space (2) is purified with a liquid disinfectant, in particular, a spray disinfectant, before and/or after the decontamination with ozone.

18. Use of ozone for the decontamination of a safety work bench (1).
